(19) United States
(12) Patent Application Publication
(10) Pub. No.: US 2007/0157308 A1
(43) Pub. Date: Jul. 5, 2007

(54) Fail-safe network authentication

(76) Inventors: Jeffrey Scott Bardsley, Bay Drive, NC (US); Nathaniel Wook Kim, Raleigh, NC (US); Charles Steven Lingafelt, Durham, NC (US); Allen Leonid Roginsky, Gaithersburg, MD (US)

Correspondence Address: Mark D. Simpson, Esquire;Synnestvedt & Lechner, 2600 Aramark Tower, 1101 Market Street, Philadelphia, PA, 19107-2950, US

(21) Appl. No.: 11/324,868

(22) Filed: Jan. 3, 2006

(51) Int. Cl. G06F 15/16

(52) U.S. Cl. 726/15

(57) ABSTRACT

An authenticator is configured with intelligence for the purpose of providing a “failsafe” mode for port-based authentication (802.1x). This failsafe mode enables end users to access a network when communication between the authenticator and the authentication server has temporarily failed, but keeps security measures in place so that unauthorized users cannot gain network access. An 802.1x access control point (e.g., a switch) is enabled to continue to authenticate certain users onto the network during periods of temporary communication failure with the authentication server, by locally storing alternative authentication information limited to historical authentication information of clients that have previously accessed the network via the authentication server. Subsequent revalidation of specific users using the primary authentication information follows restoration of communication with the authentication server.

### BACKGROUND OF THE INVENTION

1. Field of the Invention

The present invention relates to the field of networked computer systems, and more particularly, to the field of controlled access to network computers.

2. Description of the Related Art

Network computer systems allow multiple clients to access networked computers from virtually anywhere in the world where there is access to a communication link to the network. The benefits of network computers are well known and include the ability to share resources and to access data and other information from remote locations.

In most networks, there exists a need for controlling access to the network at the point of network attachment. Malware, user exploitation, and hacking are but a few of the reasons why access to the network must be provided on a controlled basis. Historically, the physical building in which the network server is located, rather than the access point, has been used as a control point for network entry. However, due to the previously mentioned problems, there has been significant recent effort devoted to the deployment of technology that enables the access point to function as a control point for network entry.

One of the most promising access control technologies is the IEEE standard 802.1x. This standard is a port-based authentication standard, since network access control is provisioned through a physical (in the case of wired access) or virtual (in the case of wireless access) port. Systems have been developed that require a user attempting to access a network to be authenticated using an authenticator component (i.e., a switch, wireless access point, etc.) which requires the user to present credentials that are verified via an authentication server. If the credentials are authenticated, the user is allowed to connect to and access the network. If the credentials cannot be authenticated, access is denied.

A problem exists, however, when failures occur at the authenticator or authentication server level. If the authenticator is unable to validate the credentials (i.e., ID and password) of those end users attempting access, all connectivity to the network is prevented, as a security measure.

A network that employs port-based authentication can experience failure if the authenticator and authentication servers cannot communicate due to various reasons, such as a network outage caused by a failure of a router or switch between the authenticator and the authentication server, a misconfiguration of system settings, such as in the EAP protocols, upon the authentication server, or IP or DNS changes disrupting the communication flow on the network.

Solutions to the above problems exist. For example, the authenticator can be configured to store multiple IP addresses of authentication servers with which to communicate. This is useful when the failure is in the authentication server, and not in the communication path. In addition, several authentication servers can be load balanced to provide backup capability in the event of a failure. This is only useful when the failure is in the authentication server, not in the communication path. Further, the authenticator can be configured to place all of the ports into “forced authentication mode”, which puts each port in open mode. This solution removes any network access security that existed, although it does allow access. Finally, the authentication server can be placed adjacent to or co-located with the authenticator, which eliminates the need for communication between the authentication server and the authenticator over the network. This increases initial expense substantially and subsequently increases the expense and complexity of maintaining a large number of authentication servers.

With each of the above solutions, in order for authentication take place, at least three components (client device, authenticator, and authentication server) need to be able to communicate. When the authentication server is unavailable, port-based authentication is not possible. Accordingly, a need exists for a network authentication method and system that can enable end users to access the network when the communication between the authenticator and the authentication server has temporarily failed, while still invoking some level of security measures to prevent unauthorized users from gaining network access.

### SUMMARY OF THE INVENTION

The present invention configures an authenticator with intelligence for the purpose of providing a “failsafe” mode for port-based authentication (802.1x). This failsafe mode enables end users to access the network when the communication between the authenticator and the authentication server has temporarily failed, but keeps security measures in place so that unauthorized users cannot gain network access. In accordance with the present invention, an 802.1x access control point (e.g., a switch) is enabled to continue to authenticate certain users onto the network during periods of temporary communication failure with the authentication server, by locally storing historical authentication information (alternative authentication information) and using the stored historical information for authentication while the communication with the authentication server is out of service. Subsequent revalidation of specific users using primary authentication information stored on the authentication server follows restoration of communication with the authentication server.

### BRIEF DESCRIPTION OF THE DRAWINGS

FIG. 1 illustrates the general configuration of a typical network using 802.1x network authentication;

FIG. 2 is a flowchart illustrating the basic steps involved in the typical operation of the system of FIG. 1;

FIG. 3 illustrates the general operation of the fail-safe authentication process of the present invention;

FIG. 4 is a flowchart illustrating a method, in accordance with the present invention, to re-authenticate a user that gained access during the period during which the authenticator was operating in the failsafe mode; and

FIG. 5 is a basic block diagram showing an authenticator 108 configured with a local authenticator database in accordance with the present invention.

### DETAILED DESCRIPTION OF THE PREFERRED EMBODIMENTS

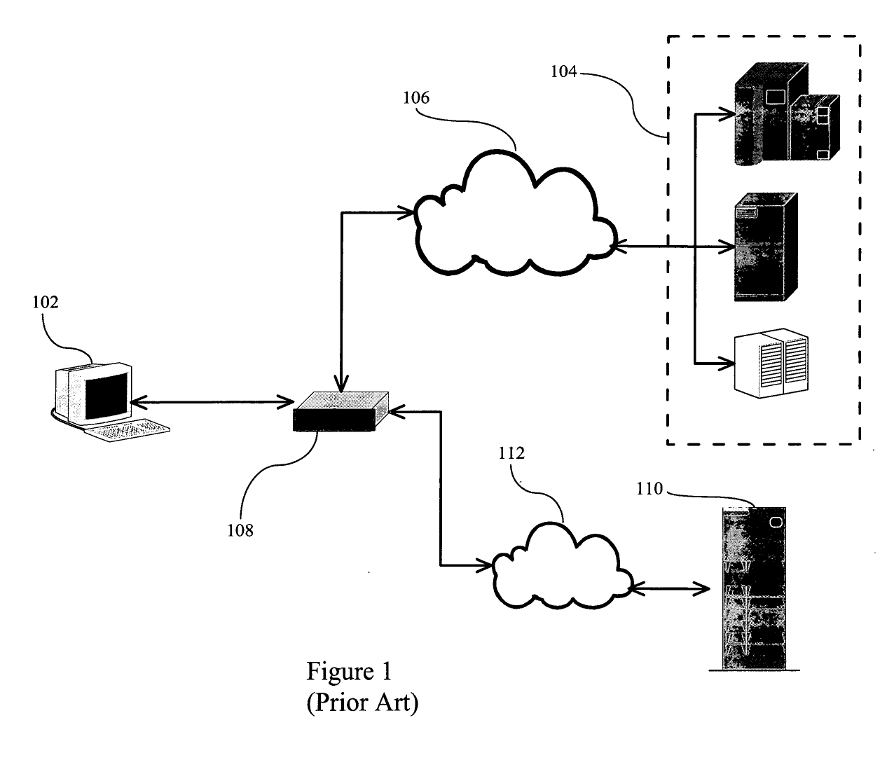

FIG. 1 illustrates the general configuration of a typical network using 802.1x network authentication. Referring to FIG. 1, an end-user using a client device 102 has access to a network 104 via a network connection 106. An authenticator 108 is coupled between client device 102 and network connection 106. As is well known, client device 102 contains a supplicant that communicates with the authenticator 108 to obtain access to the network connection 106. Authenticator 108 includes a switching function which allows selective connectability between client 102 and network connection 106 in a well known manner.

Authenticator 108 is also connected to an authentication server 110 via network connection 112. Authentication server 110 stores authentication data that is used, in connection with authenticator 108, to allow or disallow client 102 to be switched to the network connection 106. More specifically, the authentication server 110 typically stores information pertinent to the client such as ID and network access credentials, allowable network connectivity, and accounting information with respect to the network activity of client 102.

In operation, the authenticator 108 challenges the identity information supplied from the end-user via the supplicant contained in client device 102 (e.g., user name, password) to validate that the end-user using client device 102 is authorized to access the network 104. The authenticator sends the identity information to the authentication server 110 to authenticate the information received from the client device 102. The authentication server 110 responds to the authenticator 108 with a response. If the end-user of client device 102 is an authorized user, the switching function of authenticator 108 is triggered to place the port associated with client device 102 in an authenticated and forwarding state. The switch relays the authentication result to the client device. Once the user of client device 102 is authenticated and the client port is in an authorized state, the client device 102 can access network resources from network 104 via network connection 106. If the authentication is not successful, the switching function of authenticator 108 keeps the client port closed and no network traffic can go through to client device 102. It is noted that the physical connection between the client device 102 and the authenticator 108 can be a variety of media, including both wired and wireless.

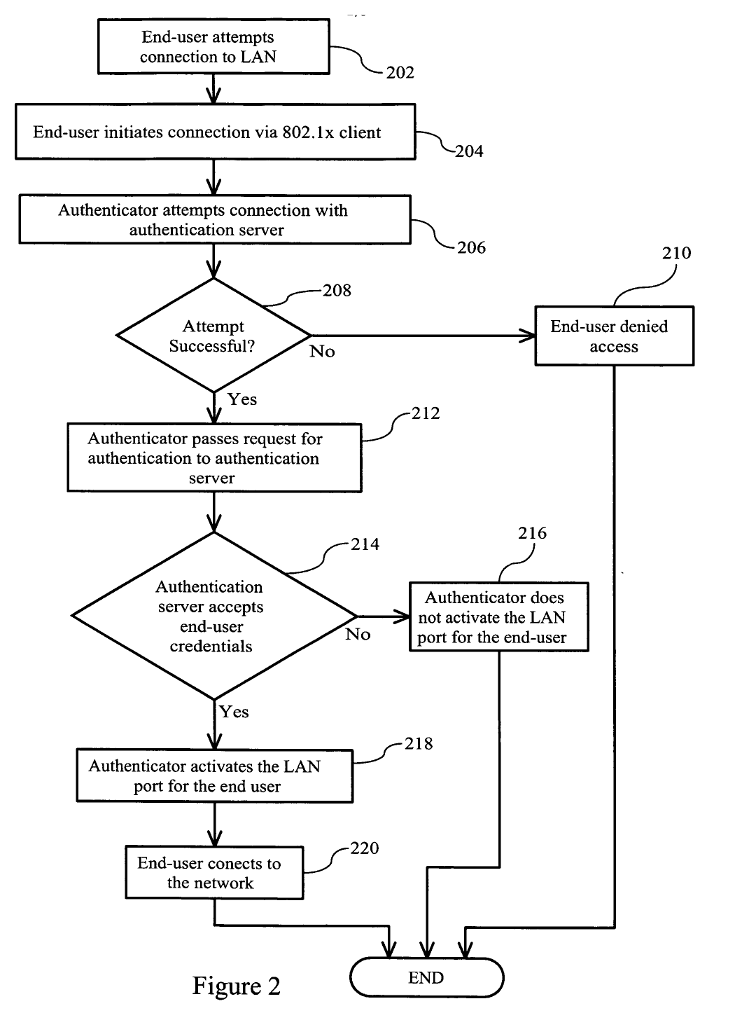

FIG. 2 is a flowchart illustrating the basic steps involved in the typical operation of the system of FIG. 1. At step 202, the end-user attempts to communicate with the network via the client, e.g., by initiating a connection via 802.1x (step 204). At step 206, the authenticator attempts communication with the authentication server.

At step 208, a determination is made as to whether or not the attempt to communicate with the authentication server has been successful. If the attempt has been unsuccessful, the process proceeds to step 210, where the end-user is denied access to the network, the process ends. If, however, at step 208 it is determined that the attempt to communicate with the authentication server has been successful, at step 212, the authenticator passes the request for authentication to the authentication server. This involves sending the complete set of authentication information supplied by the client to the authentication server.

At step 214, a determination is made as to whether or not the credentials sent during step 212 can be authenticated. If, at step 214, is determined that the credentials are unacceptable, the process proceeds to step 216, where the authenticator takes no action that would activate the network port for use by the end-user.

If, however, at step 214, the authentication server accepts the end-user credentials, then the process proceeds to step 218, were the authenticator activates the network port for the end-user, and at step 220, the end-user communicates with, e.g., connects to, the network.

As described above, if communication between the authenticator and the authentication server cannot be established, no users will be allowed to access the system, since none of them can be authenticated.

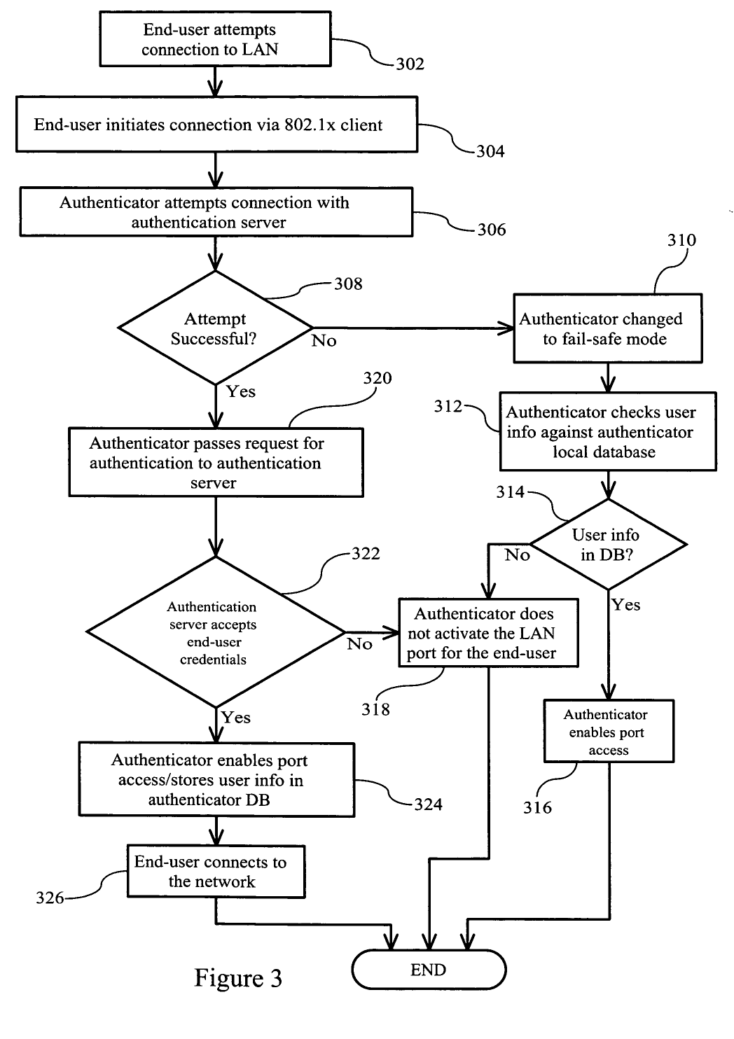

FIG. 3 illustrates the general operation of the fail-safe authentication process of the present invention. Steps 302-308, 320, and 322 are essentially identical to steps 202-208, 212, and 214 of FIG. 2; thus, the description of these steps is minimized for the sake of brevity.

In accordance with the present invention, an authenticator local database (integrated into or hardwired to the 802.1x authenticator) is provided that stores alternative authentication data, discussed in more detail below. At step 308, a query is made as to whether or not the attempt by the authenticator at step 306 to communicate with the authentication server has been successful. If this attempt is not successful, in accordance with the present invention, at step 310, the authenticator switches to a fail-safe mode. At step 312, the authenticator checks the user information input by the end-user in initiating a communication with an authenticator local database (discussed in more detail more below). At step 314, a determination is made as to whether or not there is alternative user information in the authenticator local database that matches the user information input by the end user. If it does not, the process proceeds to step 318, and the authenticator does not activate the network port for the end-user, thereby blocking that attempt by the end-user to communicate with the network.

If, however, at step 314, it is determined that there is a match between the user information and the alternative information in the authenticator local database, that the process proceeds 316, and the authenticator enables port access.

If, at step 308, the attempt to communicate with the authenticator to the authentication server is successful, at step 320, the authenticator passes the request for authentication to the authentication server. At step 322, the authentication server determines if the end-user credentials input at step 302 and 304 match the primary authentication information stored in the authentication server. If there is no match, the process proceeds to step 318, and the authenticator does not allow the network port to be activated for use by the end-user.

If, however, at step 322, there is a match, then at step 324, the authenticator enables port access. In addition, however, at step 324, the user information used to gain access is stored in the local authenticator database as alternative authentication information. It is this stored local information that allows the authenticator to perform a temporary authentication in situations where access to the authentication server is not possible. At step 326, the end-user connects to the network and the process ends.

The authenticator local database does not store or give access to a full database of information for all users that may attempt to access the network, as does the authentication server. Rather, the authenticator local database keeps a limited amount of user credentials pertaining to users that have previously accessed, successfully, the network via that particular authenticator. A user attempting to access via a particular authenticator for the first time will not be able to access the network without the authenticator being able to access the authentication server which contains or has access to data pertaining to all valid users. However, any user that has previously accessed the network via a particular authenticator will be able to be authenticated by authenticator acting on its own, in conjunction with its local database.

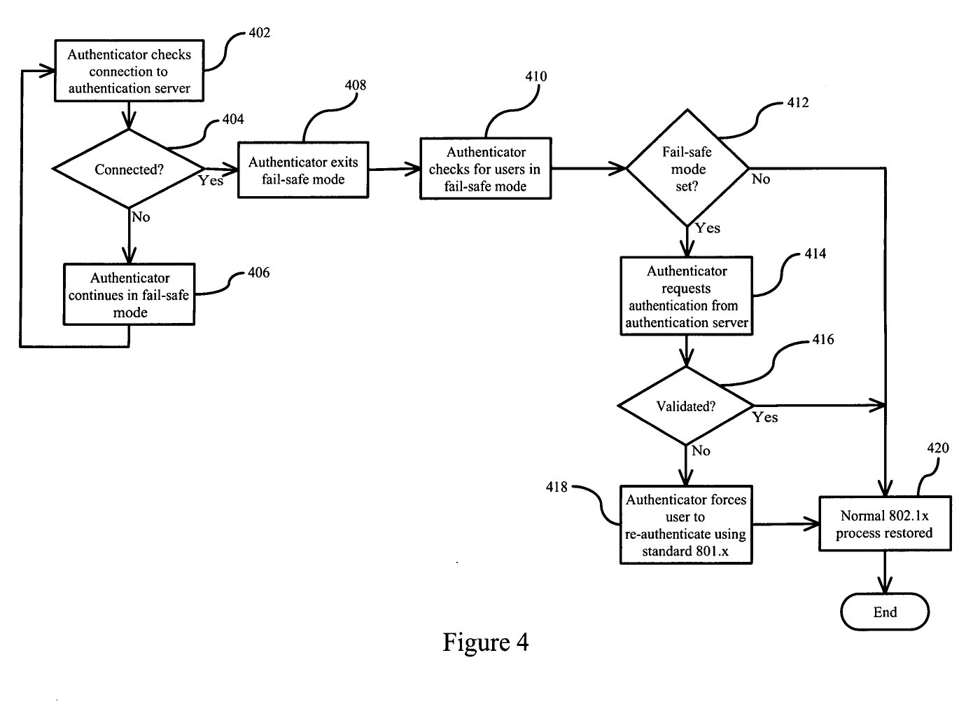

FIG. 4 is a flowchart illustrating a method, in accordance with the present invention, to re-authenticate a user that gained access during the period during which the authenticator was operating in the failsafe mode. This process assures that the higher level of security available through a full authentication via the authentication server is used as soon as it again becomes available. Referring to FIG. 4, at step 402, the authenticator checks the communication path to see if communication is possible available between the authenticator and the authentication server. At step 404, a determination is made as to whether or not such a communication is functioning. If, at step 404, it is determined that no such communication is occurring, the process proceeds to step 406, and the authenticator continues operation in the fail-safe mode.

If, however, at step 404 is determined that communication is occurring between the authenticator and the authentication server, the process proceeds to step 408, where the authenticator exits the fail-safe mode. At step 410, the authenticator checks each currently-accessing user to see if they are accessing the network based on authentication that took place while the system was in the fail-safe mode. This can be done, for example, by checking each user for the existence of a fail-safe flag or other alerting mechanism associated with the user.

At step 412, it is determined whether or not the fail-safe mode is set for a particular user. If the fail-safe mode is not set, then access by that user would be handled using a normal 802.1x process. If, however, at step 412 it is determined that the fail-safe mode is set for particular user, the process proceeds to step 414, were the authenticator requests authentication from the authentication server. If, at step 416, the request is validated, the process proceeds directly to step 420, where the normal 802.1x process restores the user to a normal access condition.

If, at step 416 it is determined that the authentication request is not validated (i.e., the proper credentials have not been supplied), then at step 418 the authenticator forces the user to re-authenticate using the standard 802.1x process. The process then proceeds to step 420 which signifies the restoration of the normal 802.1x process (assuming that the re-authentication process is successful).

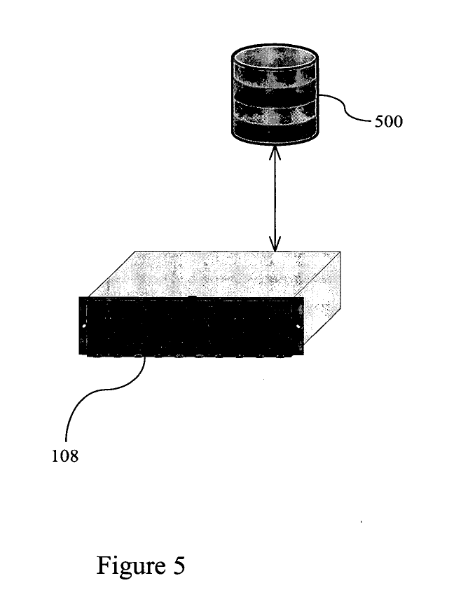

FIG. 5 is a basic block diagram showing an authenticator 108 configured with a local authenticator database in accordance with the present invention. As shown, the local authenticator database 500 is coupled to authenticator 108 so that authenticator 108 can store data to, and access data from, local authenticator database 500. Authenticator 108 is further configured with software that enables it to store the limited authentication information described above respecting users who successfully access the network via authenticator 108. While FIG. 5 shows a configuration with a local authenticator database 500 that is separate from authenticator 108, it is understood that they can be integrated into a single unit, i.e., database 500 can be a part of authenticator 108 if desired.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a device on which an IM client is running. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

For those skilled in the art, it can be seen that the fail-safe mode of the present invention can be configured to operate by specific port or by groups or collections of ports spanning one or more authentication devices. It can also be seen that the fail-safe mode of the present invention can be operated for specific configurable time periods and upon expiration of the time period, if a port or collection of ports is/are still in the fail-safe mode, the port(s) may be deactivated and the fail-safe mode exited.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A fail-safe method of authenticating a client to a network, comprising the steps of:
receiving, at an 802.1x authenticator, a request for authentication from an 802.1x supplicant contained in a client;
entering a fail-safe mode, wherein alternative authentication information stored at said 802.1x authenticator is used to authenticate said client, when primary authentication information stored on an 802.1x authentication server is unavailable; and
re-authenticating said client using said primary authentication information once said primary authentication information stored on said 802.1x authentication server is available, thereby exiting said fail-safe mode.

2. The method of claim 1, wherein said alternative authentication information comprises historical authentication information pertaining to clients that have previously successfully accessed the network via said 802.1x authenticator, said method further comprising the step of:
storing said alternative authentication information in a database local to said 802.1x authenticator.

3. The method of claim 2, further comprising the steps of:
monitoring communication between said 802.1x authenticator and said 802.1x authentication server; and
entering said fail-safe mode when the communication between said 802.1x authenticator and said 802.1x authentication server fails.

4. A fail-safe system for authenticating a client to a network, comprising:
an 802.1x authenticator coupleable to said client, said client containing an 802.1x supplicant;
an 802.1x authentication server, coupleable to said 802.1x authenticator, storing primary authentication information; and
a database local to said 802.1x authenticator, storing alternative authentication information, wherein:
said alternative authentication information is used to authenticate said client when said primary authentication information is unavailable.

5. The system of claim 4, wherein said client is reauthenticated using said primary authentication information when said primary authentication is available.

6. The system of claim 5, wherein said alternative authentication information comprises historical authentication information limited to authentication information pertaining to clients that have previously successfully accessed the network via said 802.1x authenticator.

7. A fail-safe computer program product for authenticating a client to a network, the computer program product comprising a computer-readable storage medium having computer readable program code embodied in the medium, the computer-readable program code comprising:
computer-readable program code that receives, at an 802.1x authenticator, a request for authentication from an 802.1x supplicant contained in a client;
computer-readable program code that configures said 802.1x authenticator to enter a fail-safe mode, wherein alternative authentication information stored at said 802.1x authenticator is used to authenticate said client when primary authentication information stored on an 802.1x authentication server is unavailable; and
computer-readable program code that re-authenticates said client using said primary authentication information once said primary authentication information stored on said 802.1x authentication server is available, thereby exiting said fail-safe mode.

8. The computer program product of claim 7, wherein said alternative authentication information comprises historical authentication information pertaining to clients that have previously successfully accessed the network via said 802.1x authenticator, said method further comprising:
computer-readableprogram code that stores said alternative authentication information in a database local to said 802.1x authenticator.

9. The computer program product of claim 8, further comprising:
computer-readable program code that monitors communication between said 802.1x authenticator and said 802.1x authentication server; and
computer-readable program code that enters said fail-safe mode when the communication between said 802.1x authenticator and said 802.1x authentication server fails.
